(19) United States
(12) Patent Application Publication
(10) Pub. No.: US 2019/0172434 A1
(43) Pub. Date: Jun. 6, 2019

(54) Piano Key Press Processor

(71) Applicant: Gary S. Pogoda, Atlantic City, NJ (US)

(72) Inventor: Gary S. Pogoda, Atlantic City, NJ (US)

(21) Appl. No.: 16/189,315

(22) Filed: Nov. 13, 2018

Related U.S. Application Data
(60) Provisional application No. 62/594,224, filed on Dec. 4, 2017.
(60) Provisional application No. 62/608,620, filed on Dec. 21, 2017.
(60) Provisional application No. 62/717,057, filed on Aug. 10, 2018.

(51) Int. Cl. G10H 1/38; G10H 1/34

(52) U.S. Cl. CPC G10H 1/386; G10H 1/34; G10H 1/383

(57) ABSTRACT

The present invention relates to a piano key press processor for a piano keyboard, which analyzes the key press characteristics of simple chord voicings during play, flags the pressed keys having specific such characteristics, and repurposes those flagged keys, so as to play the chord in a more advanced chord voicing.

### CROSS-REFERENCE TO RELATED APPLICATIONS

This application claims the benefit of prior Provisional Application Ser. No. 62/594,224, filed Dec. 4, 2017; prior Provisional Application Ser. No. 62/608,620, filed Dec. 21, 2017 and prior Provisional Application Ser. No. 62/717,057, filed Aug. 10, 2018.

### BACKGROUND OF THE INVENTION

The present invention is directed toward the playing of piano chords, and more specifically, toward the difficulty in playing advanced, piano chord voicings, such as, but not limited to, ‘open-position’ chord voicings.

For piano players with tiny to average-size hands, even for accomplished such players, open-position chords, where the chord notes extend beyond a one-octave range, can be difficult to reach with a single hand. Consequently, novice players might opt for two-handed playing of such chords. More accomplished players will often utilize a one-handed ‘rolling’ technique, which can also be quite difficult.

Hence the need for a simple method of playing advanced chord voicings. This invention provides just that by sensing piano key presses during play, flagging keys with specific key press characteristics, and repurposing those flagged keys as needed. This can be accomplished in many ways, including, but certainly not limited to, physical or electronic connections made between a keyboard and an invention implementation internal to a piano, MIDI I/O communicated with an invention implementation external to a piano, and audio signal I/O communicated with an invention implementation internal or external to a piano. It also can be applied to any type of piano, including, but again not limited to, digital, acoustic, and hybrid pianos.

For such an invention to be useful, the specific key press characteristics for which a key is flagged should NOT regularly occur during normal playing; otherwise, the repurposing could be initiated unintentionally. To guard against this happening, the present invention capitalizes on the fact that certain key press combinations, timing, and touch positioning, along with pressed key count and relative pedal press timing factored in supplementarily, are unlikely to be used during normal playing.

An example of an unlikely key press combination, with pressed key count factored in supplementarily, would be the concurrent pressing of two adjacent keys. It is not that such proximate key pressing is never used, it is just not normally used due to the dissonant sound of two notes played one semitone apart. Thus, if this unlikely scenario were detected during play, it would be safe to assume that the adjacent keys were intended to be flagged by the analysis for possible repurposing.

One example of unlikely key press timing, with pressed key count and relative pedal press timing factored in supplementarily, would be the playing of a chord with all its key presses having been simultaneously initiated, and at least one (but not all unless with concurrent pedal pressing) of its key presses being terminated immediately thereafter. If this unlikely scenario were detected during play, it would be safe to assume that the immediately terminated keys were intended to be flagged by the analysis for possible repurposing.

A second example of unlikely key press timing, with pressed key count and relative pedal press timing factored in supplementarily, would be the playing of a chord with two or more key presses (one or more with concurrent pedal pressing) having been initiated simultaneously, and one or more key presses being initiated slightly delayed. If this unlikely scenario were detected during play, it would be safe to assume that the slightly delayed keys were intended to be flagged by the analysis for possible repurposing.

To enhance the guard against unintentional repurposing in the above examples, relative pedal press timing could be further utilized supplementarily to direct whether or not the flagged keys should be repurposed.

An example of unlikely key press touch positioning would be designating a small area of each key as a control area, whereby, anytime a key press was detected in this area, that key would be repurposed. In order for this type of detection to be useful, the control area would have to be one that can be easily avoided during normal playing. Also, the touch sensors used to detect such key presses would have to be inexpensive, considering that one such sensor would be required for each of possibly 88 piano keys.

Although the sophistication of the control-area analysis described above is limited by the use of inexpensive sensors, it would be obvious to one skilled in the art that, if more extensive analysis were desired, use of additional and/or more expensive sensors would enable such analysis. For example, if the entire top surface of each key were outfitted with touch sensors equivalent to those of an iPhone or iPad touch screen, it would then be a simple matter to flag, say, a particular touch position along a pressed key, multiple touch positions along a pressed key, touch position sliding, and key press points relative to that of other pressed keys.

While outfitting each key with such touch sensors would enable a variety of additional repurposing possibilities, including incremental, sub-octave, multi-octave, and bi-directional note shifting, doubling, supplementing, and/or sliding, it would also contribute significantly to the expense to the invention, considering that as many as 88 keys would need to be outfitted in this way. To the contrary, only one of the preferred embodiments for the present invention requires more than a single inexpensive touch sensor per key, and most require no touch sensors at all.

It should be noted that the chord processing herein disclosed for piano key pressing, could be just as easily applied to key pressing unrelated to chords, to musical instruments unrelated to key pressing, to devices unrelated to musical instruments, and to other situations where events can be similarly repurposed.

### SUMMARY OF THE INVENTION

The present invention relates to a piano key press processor for a piano keyboard, which analyzes the key press characteristics of simple chord voicings during play, flags the pressed keys having specific such characteristics, and repurposes those flagged keys, so as to play the chord in a more advanced chord voicing.

### BRIEF DESCRIPTION OF THE DRAWINGS

To illustrate this invention, there are shown in the accompanying drawings embodiments that are presently preferred, it being understood that the invention is not intended to be limited to the precise arrangements and instrumentalities shown.

FIGS. 1-22 are embodiments of a piano keyboard of the invention;

FIGS. 23A and 23B are embodiments of a piano keyboard and piano pedal switch, respectively, of the invention;

FIG. 24 is a flow chart of the embodiments of FIGS. 1-22; and

FIG. 25 is a flow chart of the embodiments of FIGS. 23A and 23B.

### DETAILED DESCRIPTION OF THE PREFERRED EMBODIMENTS

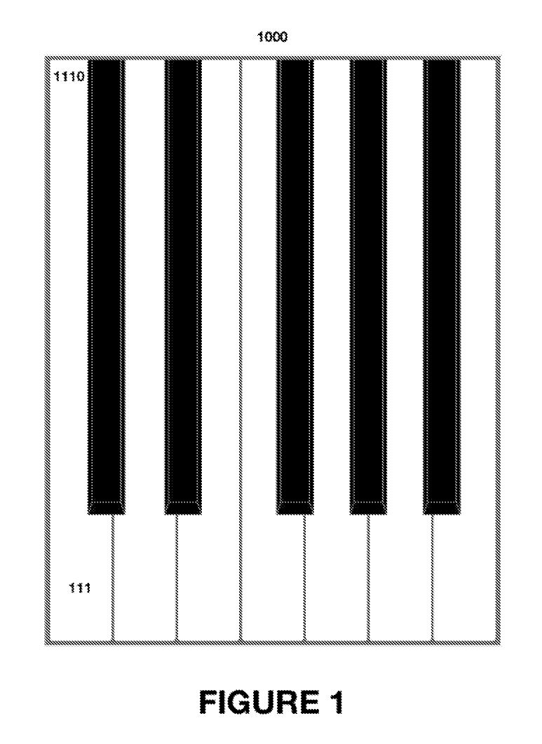

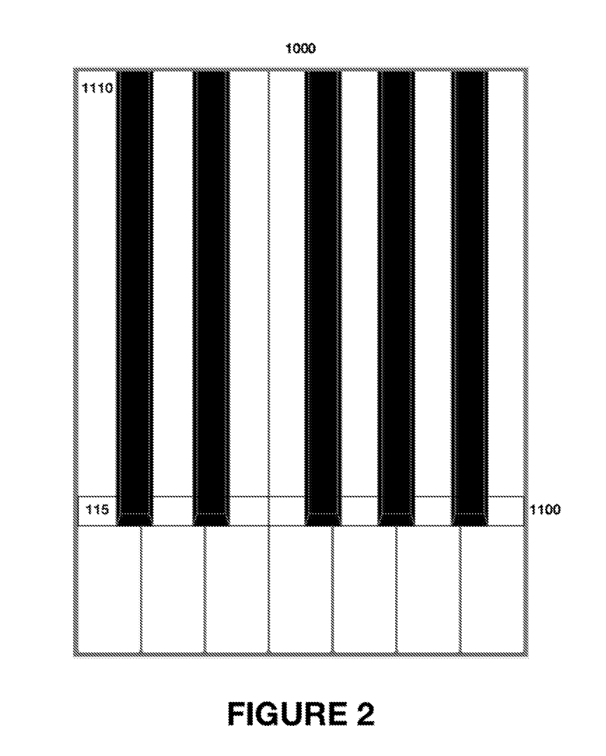

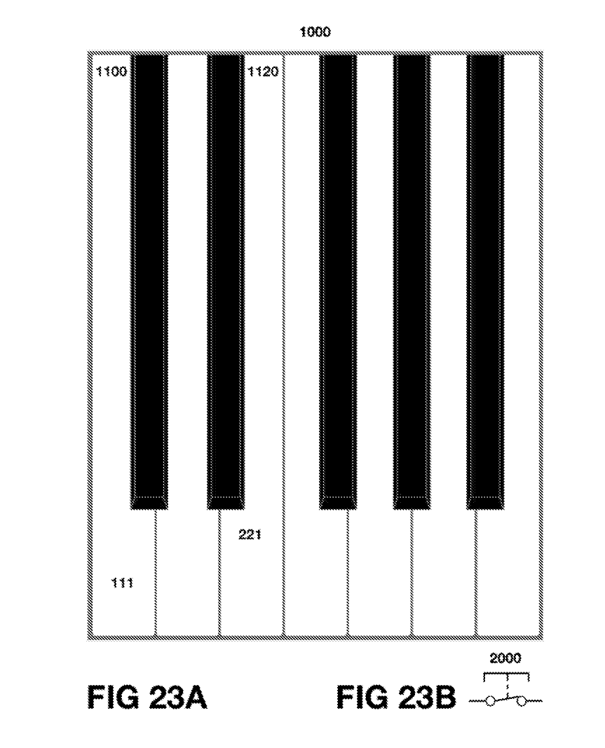

Referring now to the accompanying drawings in detail, wherein like reference numerals have been used throughout the various figures to designate like elements, there is shown in FIGS. 1-23A, a single-octave piano keyboard 1000, as viewed from a top perspective. FIGS. 2, 3, 7, 8, 13, and 14 further show a touch sensor cluster 1100 linearly mounted across the width of the keyboard 1000, such that each key of the keyboard 1000 has a separate, independently operated, touch sensor mounted atop it. FIG. 23B shows a standard piano pedal switch 2000.

For all figures, the various parts of the piano keyboard 1000 are numbered with four-digit numerals, and the key presses of the keyboard 1000 are numbered with three-digit numerals. Additionally, for all figures, key presses with the same first digit also have the same most recent initiation time, and the higher that first digit, the later that initiation time. Alternatively, for all figures, key presses with a first digit numeral greater than one, also have the same most recent initiation time as key presses with that first digit numeral decremented by one, and have a termination time immediately thereafter. For simplicity, this alternative is not specifically discussed in the following figure descriptions; however, it should be understood that it is always an option, and may even be a preferable option.

FIG. 1 shows the C4-key 1110 (middle C) being pressed at a single location 111 and playing the note C4. This is the normal playing function.

FIG. 2 shows the C4-key 1110 being pressed at a single location 115 and, due to it being pressed at a position within the touch sensor cluster 1100, playing the two notes, C4 and C5. This modifies the normal playing function by doubling the C4-key 1110, and does so by sensing pressed key touch positioning.

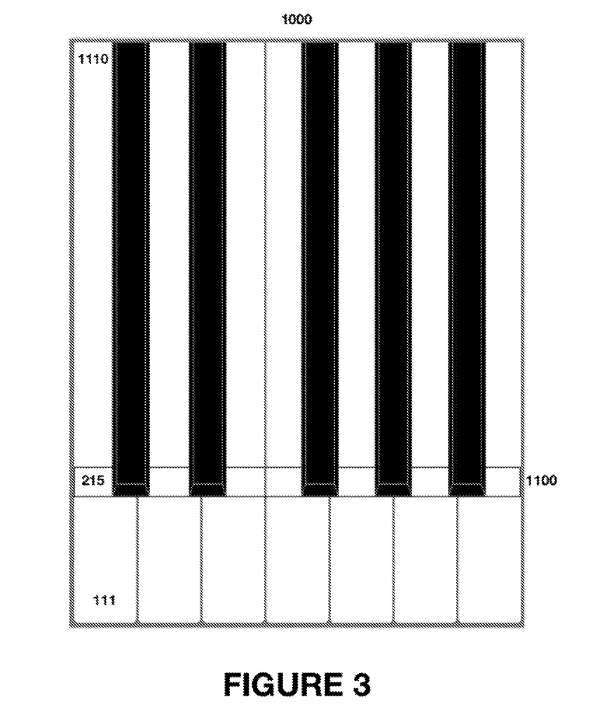

FIG. 3 shows the C4-key 1110 being (touched and) pressed at a first location 111 and playing the note C4, and being nearly simultaneously (touched and) pressed at a second location 215 and, due to it being multiply touched, as well as nearly simultaneously pressed at a position within the touch sensor cluster 1100, playing the note C5. This modifies the normal playing function by doubling the C4-key 1110, and does so by sensing key press timing, pressed key touch multiplicity, and pressed key touch positioning.

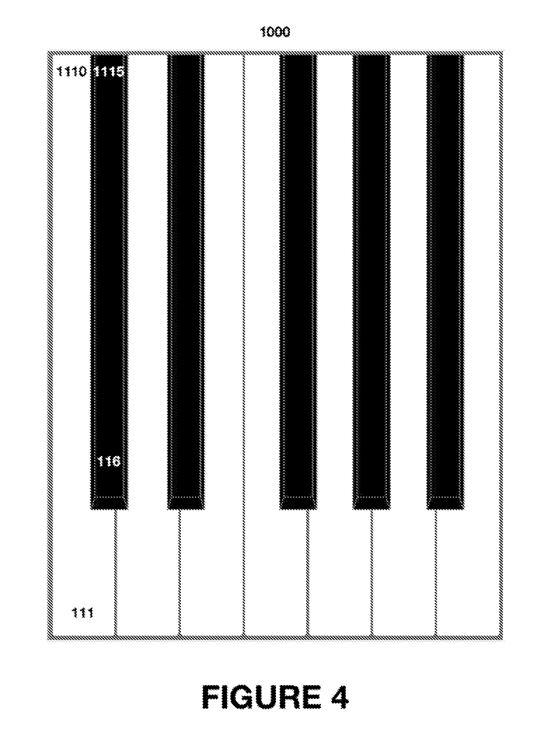

FIG. 4 shows the C4-key 1110 being pressed at a single location 111 and playing the note C4, and the C#4 1115 being simultaneously pressed at a single location 116 and, due to the simultaneous pressing and proximity of the C4-key 1110 and C4#-key 1115, with the second-pressed C#4-key 1115 being higher pitched than the first-pressed C4-key 1110, playing the note C5. This modifies the normal playing function by replacing the note of the C#4-key 1115 with C5 so as to double the C4-key 1110 (or in the alternative, replacing the note of the C#4-key 1115 with a supplemental note), and does so by sensing key press timing and relative pressed key proximity.

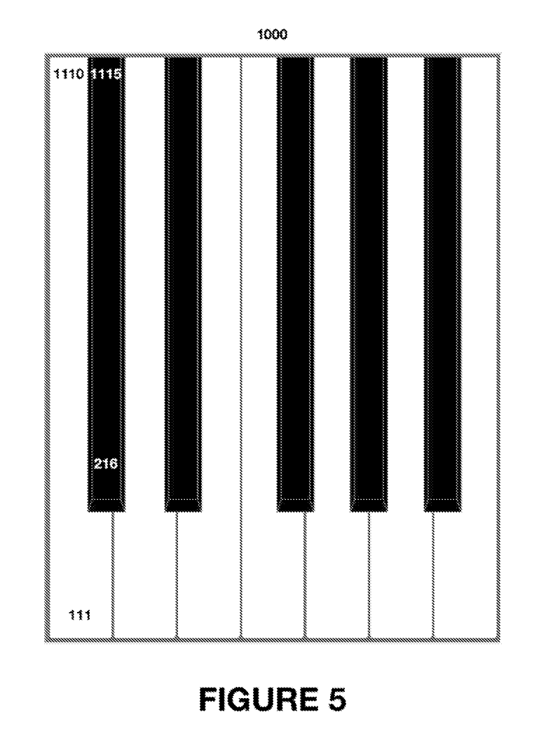

FIG. 5 shows the C4-key 1110 being pressed at a single location 111 and playing the note C4, and the C#4-key 1115 being nearly simultaneously pressed at a single location 216 and, due to the nearly simultaneous pressing and proximity of the C4-key 1110 and C#4-key 1115, with the second-pressed C#4-key 1115 being higher pitched than the first-pressed C4-key 1110, playing the note C5 slightly delayed. This modifies the normal playing function by replacing the note of the C#4-key 1115 with C5 so as to double the C4-key 1110 (or in the alternative, replacing the note of the C#4-key 1115 with a supplemental note), and does so by sensing key press timing and relative pressed key proximity.

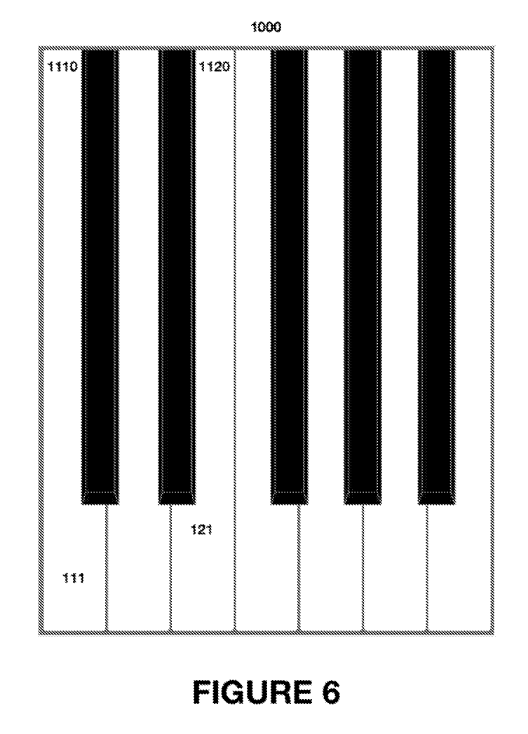

FIG. 6 shows the C4-key 1110 being pressed at a single location 111 and playing the note C4, and the E4-key 1120 being simultaneously pressed at a single location 121 and playing the note E4. This is the normal playing function.

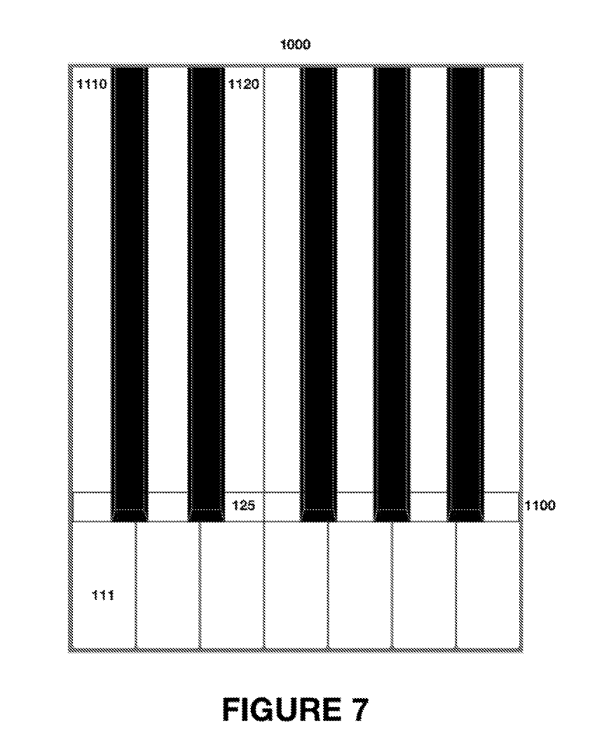

FIG. 7 shows the C4-key 1110 being pressed at a single location 111 and playing the note C4, and the E4-key 1120 being simultaneously pressed at a single location 125 and, due to it being simultaneously pressed at a position within the touch sensor cluster 1100, playing the notes E4 and E5. This modifies the normal playing function by doubling the E4-key 1120, and does so by sensing key press timing and pressed key touch positioning.

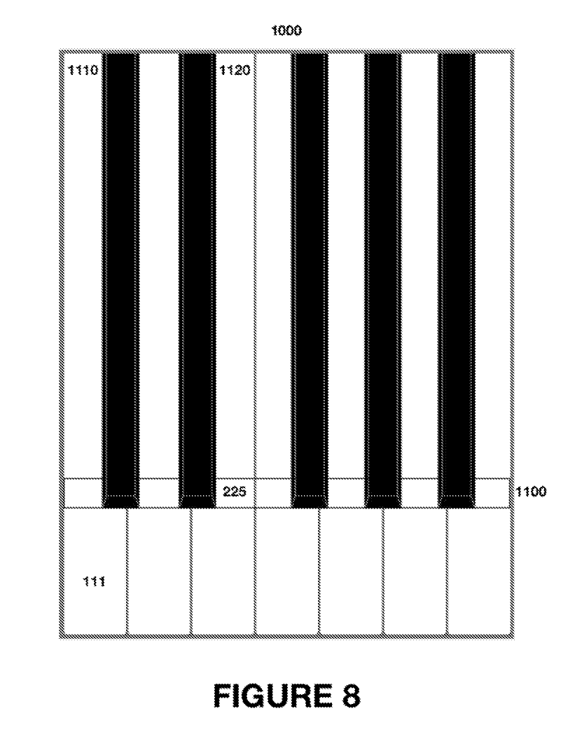

FIG. 8 shows the C4-key 1110 being pressed at a single location 111 and playing the note C4, and the E4-key 1120 being nearly simultaneously pressed at a single location 225 and, due to it being nearly simultaneously pressed at a position within the touch sensor cluster 1100, playing the note E5 slightly delayed. This modifies the normal playing function by playing the close-position E4-key in open position, and does so by sensing key press timing and pressed key touch positioning.

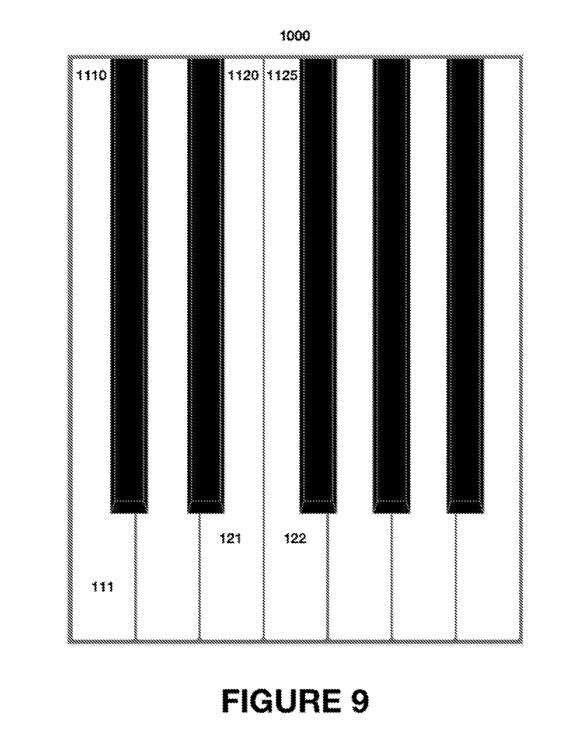

FIG. 9 shows the C4-key 1110 being pressed at a single location 111 and playing the note C4, and the E4-key 1120 plus F4-key 1125 being simultaneously pressed at separate locations 121 and 122, respectively, and, due to the simultaneous pressing and proximity of the E4-key 1120 and F4-key 1125, with the second-pressed F4-key 1125 being higher pitched than the first-pressed E4-key 1120, playing the note E5. This modifies the normal playing function by playing the close-position E4-key 1120 in open position, but muting the F4-key 1125, and does so by sensing key press timing and relative pressed key proximity.

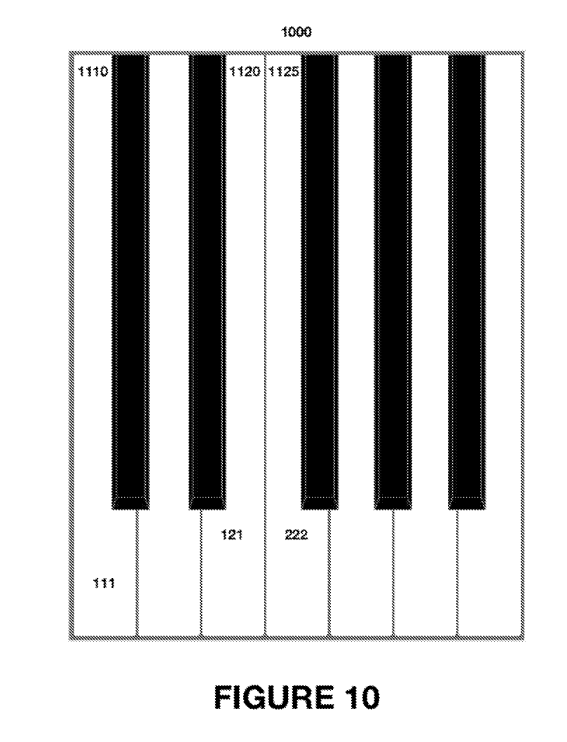

FIG. 10 shows the C4-key 1110 being pressed at a single location 111 and playing the note C4, the E4-key 1120 being simultaneously pressed at a single location 121 and playing the note E4, and the F4-key 1125 being nearly simultaneously pressed at a single location 222 and, due to the nearly simultaneous pressing and proximity of the E4-key 1120 and F4-key 1125, with the second-pressed F4-key 1125 being higher pitched than the first-pressed E4-key 1120, playing the note E5 slightly delayed. This modifies the normal playing function by replacing the note of the F4-key 1125 with E5 so as to double the E4-key 1120 (or in the alternative, replacing the note of the F4-key 1125 with a supplemental note), and does so by sensing key press timing and relative pressed key proximity.

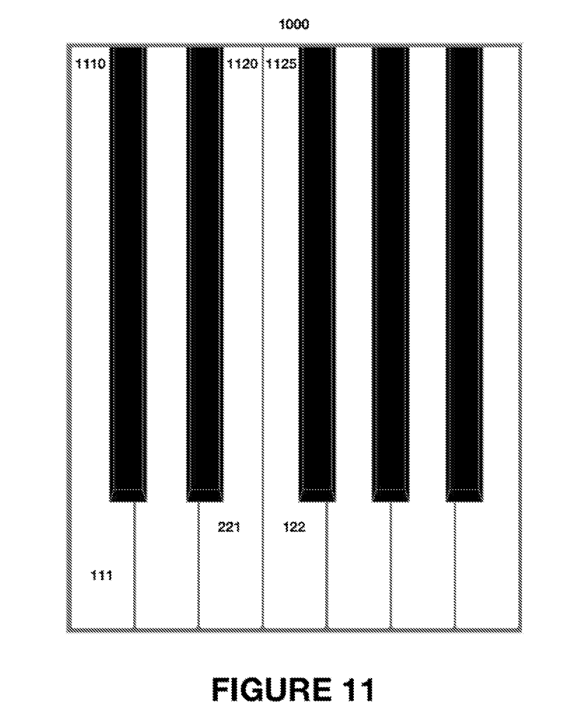

FIG. 11 shows the C4-key 1110 being pressed at a single location 111 and playing the note C4, the F4-key 1125 being simultaneously pressed at a single location 122 and playing the note F4, and the E4-key 1120 being nearly simultaneously pressed at a single location 221 and, due to the nearly simultaneous pressing and proximity of the E4-key 1120 and F4-key 1125, with the second-pressed E4-key 1120 being lower pitched than the first-pressed F4-key 1125, playing the note F3 slightly delayed. This modifies the normal playing function by replacing the note of the E4-key 1120 with F3 so as to double the F4-key 1125 (or in the alternative, replacing the note of the E4-key 1120 with a supplemental note), and does so by sensing key press timing and relative pressed key proximity.

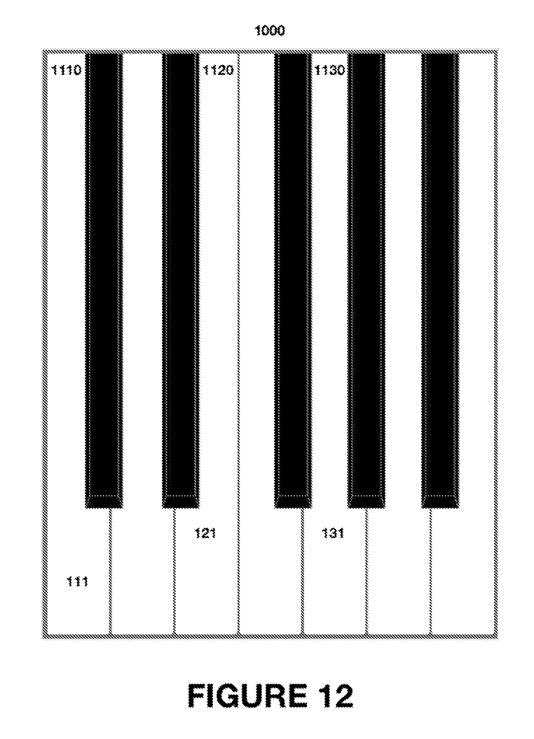

FIG. 12 shows the C4-key 1110 being pressed at a single location 111 and playing the note C4, the E4-key 1120 being simultaneously pressed at a single location 121 and playing note E4, and the G4-key 1130 being simultaneously pressed at a single location 131 and playing the note G4. This is the normal playing function.

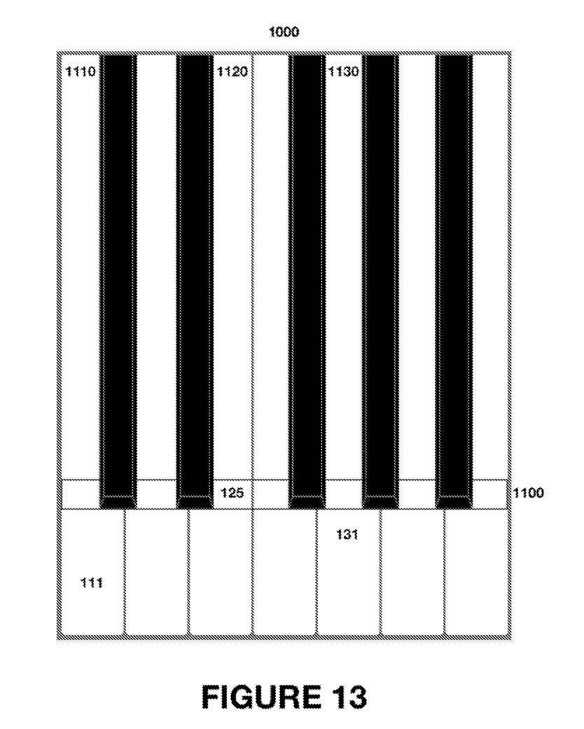

FIG. 13 shows the C4-key 1110 being pressed at a single location 111 and playing the note C4, the G4-key 1130 being simultaneously pressed at a single location 131 and playing the note G4, and the E4-key 1120 being simultaneously pressed at a single location 125 and, due to it being simultaneously pressed at a position within the touch sensor cluster 1100, playing notes E4 and E5. This modifies the normal playing function by doubling the E4-key 1120, and does so by sensing key press timing and pressed key touch positioning.

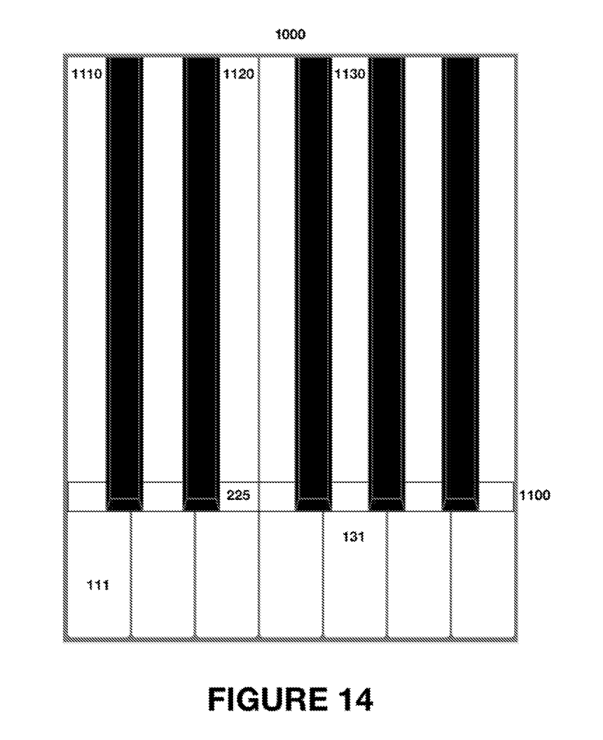

FIG. 14 shows the C4-key 1110 being pressed at a single location 111 and playing the note C4, the G4-key 1130 being simultaneously pressed at a single location 131 and playing the note G4, and the E4-key 1120 being nearly simultaneously pressed at a single location 225 and, due to it being nearly simultaneously pressed at a position within the touch sensor cluster 1100, playing the note E5 slightly delayed. This modifies the normal playing function by playing the close-position E4-key 1120 in open position, and does so by sensing key press timing and pressed key touch positioning.

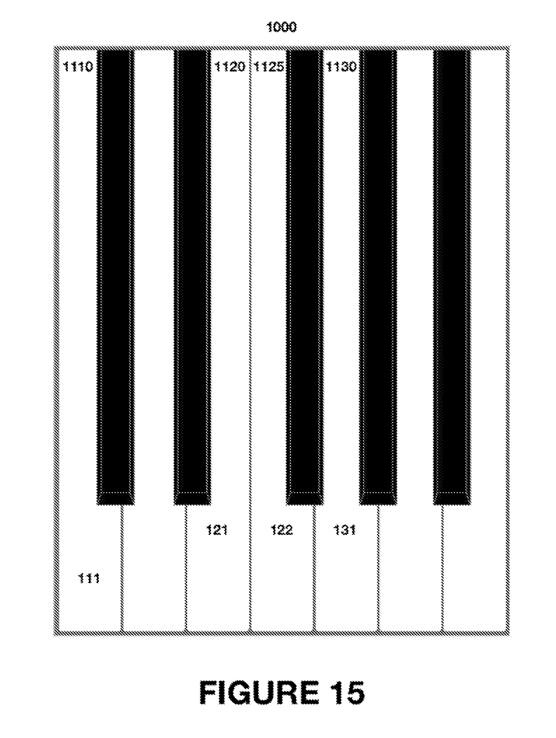

FIG. 15 shows the C4-key 1110 being pressed at a single location 111 and playing the note C4, the G4-key 1130 being simultaneously pressed at a single location 131 and playing the note G4, and the E4-key 1120 plus F4-key 1125 being simultaneously pressed at separate locations 121 and 122, respectively, and, due to the simultaneous pressing and proximity of the E4-key 1120 and F4-key 1125, playing note E5. This modifies the normal playing function by playing the close-position E4-key 1120 in open position, but muting the F4-key 1125, and does so by sensing key press timing and relative pressed key proximity.

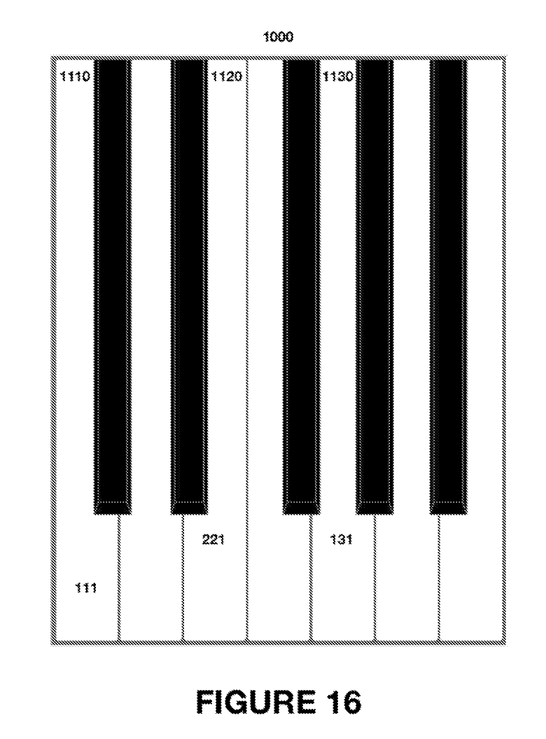

FIG. 16 shows the C4-key 1110 being pressed at a single location 111 and playing the note C4, the G4-key 1130 being simultaneously pressed at a single location 131 and playing the note G4, and the E4-key 1120 being nearly simultaneously pressed at a single location 221 and, due to it being pressed nearly simultaneously with a supplemental count of multiple simultaneously pressed keys, playing note E5 slightly delayed. This modifies the normal playing function by playing the close-position E4-key 1120 in open position, and does so by sensing key press timing and pressed key count.

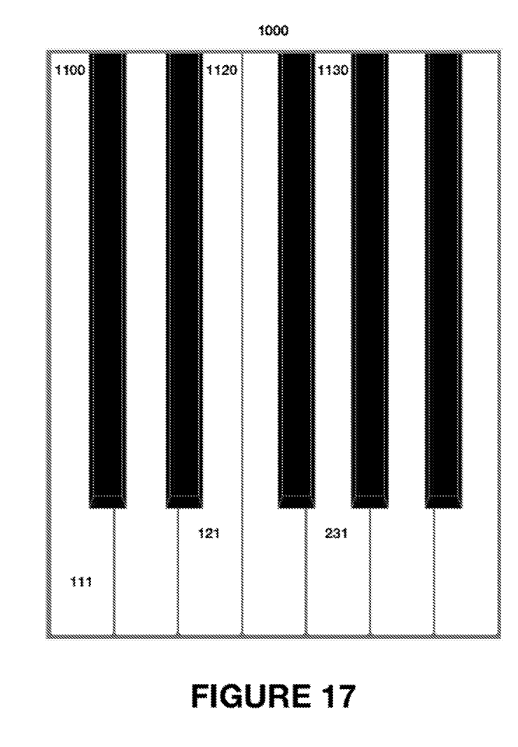

FIG. 17 shows the C4-key 1110 being pressed at a single location 111 and playing the note C4, the E4-key 1120 being simultaneously pressed at a single location 121 and playing the note E4, and the G4-key 1130 being nearly simultaneously pressed at a single location 231 and, due to it being pressed nearly simultaneously with a supplemental count of multiple simultaneously pressed keys, playing note G5 slightly delayed. This modifies the normal playing function by playing the close-position G4-key 1130 in open position, and does so by sensing key press timing and pressed key count.

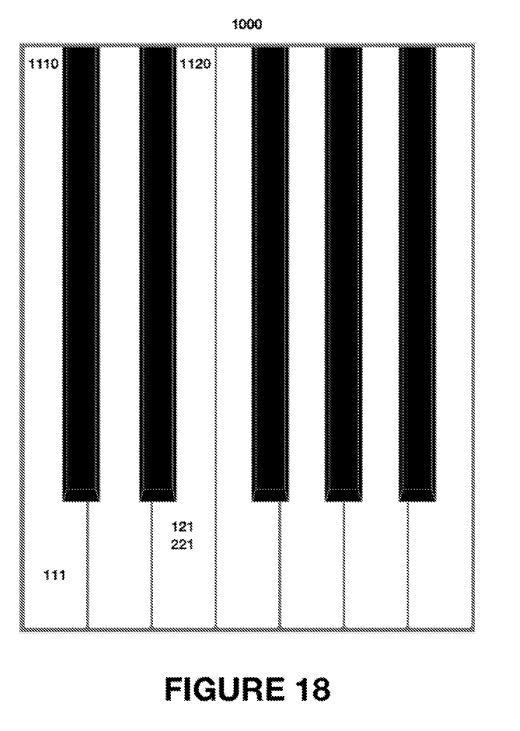

FIG. 18 shows the C4-key 1110 being pressed at a single location 111 and playing the note C4, and the E4-key 1120 being simultaneously pressed at a single location 121, then immediately released and pressed again at a single location 221, and, due to it being pressed simultaneously with a supplemental count of one other key, immediately released, and immediately pressed again, playing (or in the alternative, muting) the note E4 at the time of its first press 121, and playing the note E5 at the time of its second press 221. This modifies the normal playing function by doubling the E4-key 1120 (or in the alternative, playing the close-position E4-key 1120 in open-position), and does so by sensing key press timing and pressed key count.

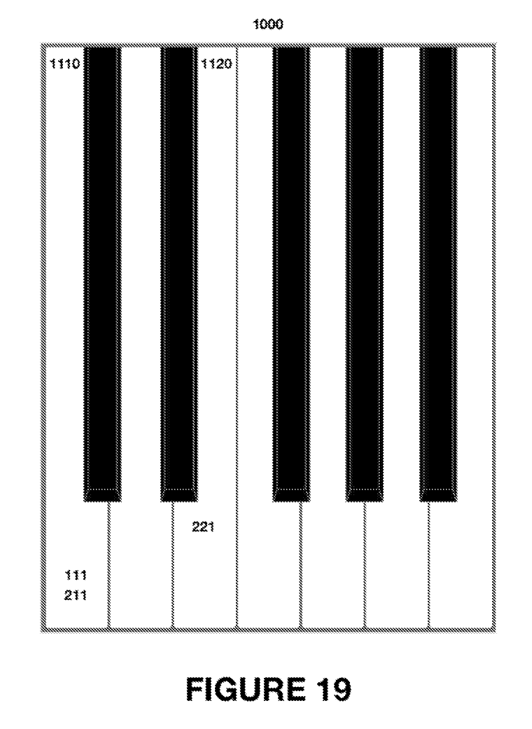

FIG. 19 shows the C4-key 1110 being pressed at a single location 111, then immediately released and pressed again at a single location 211, and playing the note C4, and the E4-key 1120 being pressed at a single location 221 simultaneously with the second press of the C4-key 1110 and, due to it being pressed simultaneously with the second press of a supplemental count of one other key that was pressed with a supplemental count of zero other keys, immediately released, and immediately pressed again, playing the note E5. This modifies the normal playing function by doubling the E4-key 1120, and does so by sensing key press timing and pressed key count.

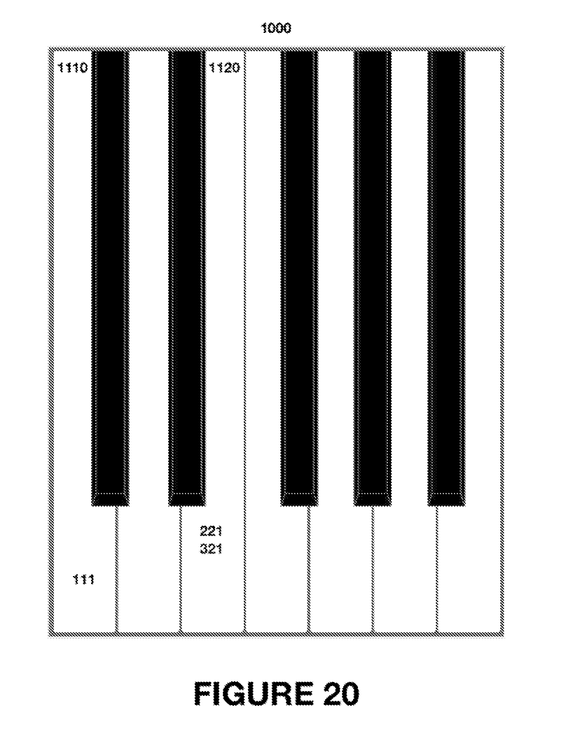

FIG. 20 shows the C4-key 1110 being pressed at a single location 111 and playing the note C4, and the E4-key 1120 being nearly simultaneously pressed at a single location 221, then immediately released and pressed again at a single location 321, and, due to it being pressed nearly simultaneously with a supplemental count of one other key, immediately released, and immediately pressed again, playing the note E5 at the time of its second press 321. This modifies the normal playing function by playing the close-position E4-key 1120 in open-position, and does so by sensing key press timing and pressed key count.

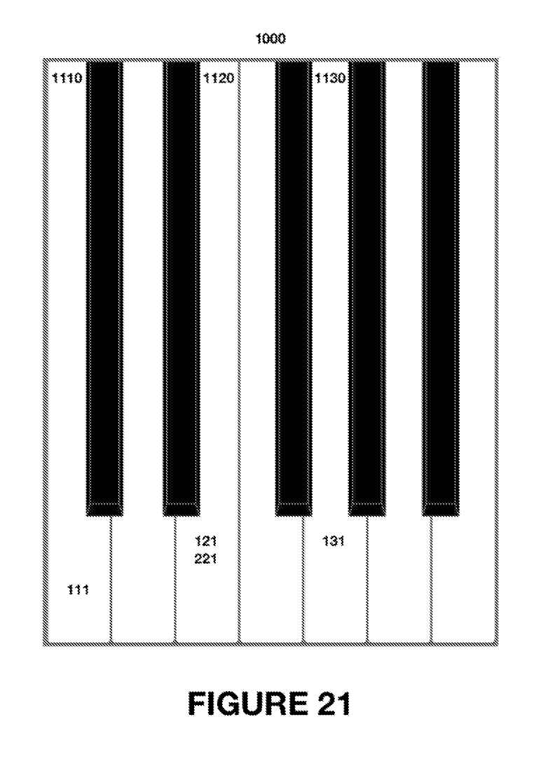

FIG. 21 shows the C4-key 1110 being pressed at a single location 111 and playing the note C4, the G4-key 1130 being simultaneously pressed at a single location 131 and playing the note G4, and the E4-key 1120 being simultaneously pressed at a single location 121, then immediately released and pressed again at a single location 221, and, due to it being pressed simultaneously with a supplemental count of multiple keys, immediately released, and immediately pressed again, playing note E4 at the time of its first press 121, and playing note E5 at the time of its second press 221. This modifies the normal playing function by doubling the E4-key 1120, and does so by sensing key press timing and pressed key count.

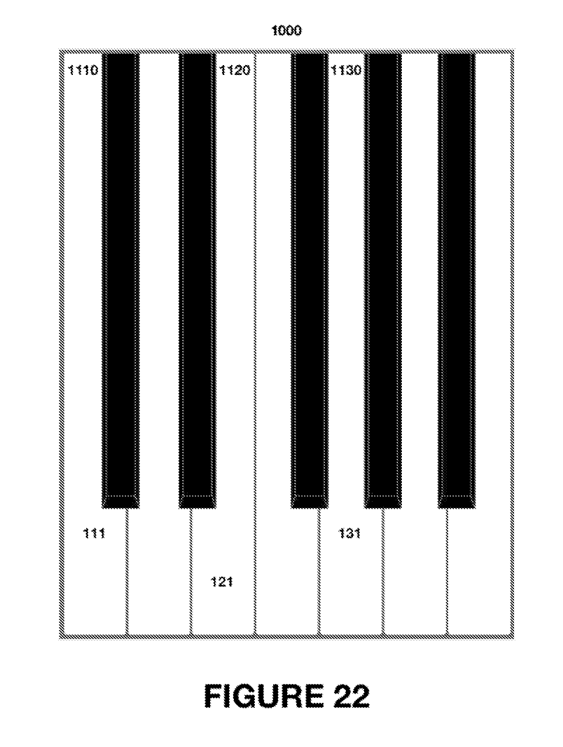

FIG. 22 shows the E4-key 1120 being pressed at a single location 121 and playing the note E4, the G4-key 1130 being simultaneously pressed at a single location 131 and playing the note G4, and the C4-key 1110 being simultaneously pressed at a single location 111 and, due to it being a lower note key than the E4-key 1120 and the E4-key 1120 being pressed at the lowest of the three press points 111, 121, and 131, playing the note E5. This modifies the normal playing function by shifting the E4-key 1120 to the note of a key not shown on the keyboard, and does so by sensing key press timing and relative key press points.

FIGS. 23A and 23B shows the normally open, momentary, piano pedal switch 2000 being concurrently pressed with the C4-key 1110 being pressed at a single location 111 and playing the note C4, and the E4-key 1120 being nearly simultaneously pressed at a single location 221, and due to it being nearly simultaneously pressed, and supplementarily due to the pedal switch 2000 being concurrently pressed, playing the note E5 slightly delayed. This modifies the normal playing function by playing the close-position E4-key in open position, and does so by sensing key press timing and relative pedal press timing.

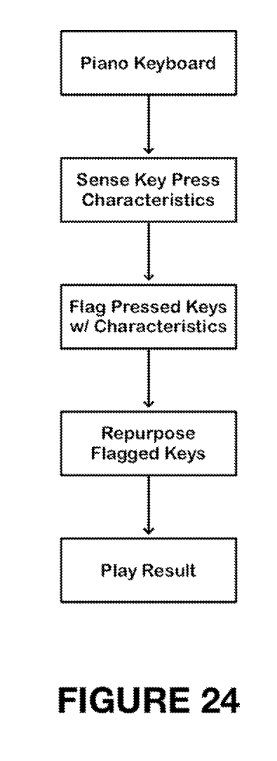

FIG. 24 shows the operational steps for FIGS. 1-22.

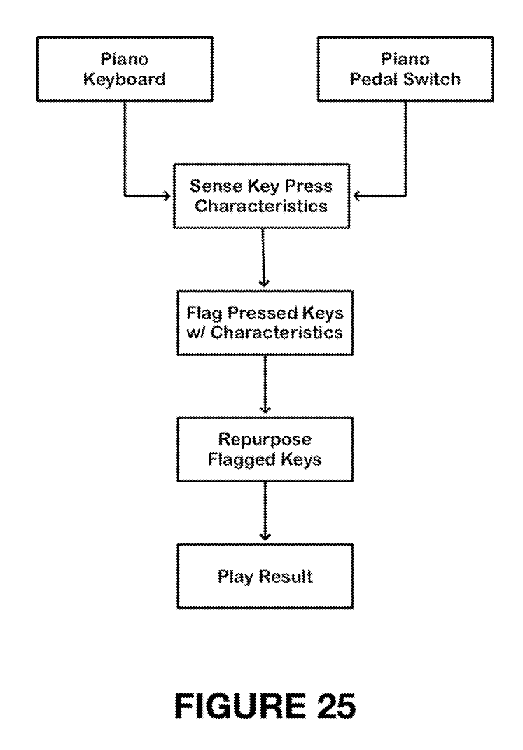

FIG. 25 shows the operational steps for FIGS. 23A and 23B.

I claim:

1. A piano key press processor for a piano keyboard, where said piano key press processor includes:
means for sensing key press characteristics,
means for flagging keys having specific said characteristics, and
means for repurposing said flagged keys.

2. The piano key press processor as claimed in claim 1, where said key press characteristics include at least one of the following:
key press timing,
pressed key count,
pressed key touch multiplicity,
relative pressed key proximity,
relative key press points,
relative pedal press timing, and
key touch positioning.

3. The piano key press processor as claimed in claim 1, where said sensing means include at least one of the following:
key press timing sensors,
key counting sensors,
key touch multiplicity sensors,
relative pressed key proximity sensors,
relative key press point sensors,
relative pedal press timing sensors, and
key touch positioning sensors.

4. The piano key press processor as claimed in claim 1, where said repurposing mean includes at least one of the following:
note muting,
note replacing,
note shifting,
note doubling,
note supplementing, and
note sliding.

5. The piano key press processor as claimed in claim 1, where:
said key press characteristics include at least one of the following:
key press timing,
pressed key count,
pressed key touch multiplicity,
relative pressed key proximity,
relative key press points,
relative pedal press timing, and
key touch positioning; and
said sensing means include at least one of the following:
key press timing sensors,
key counting sensors,
key touch multiplicity sensors,
relative pressed key proximity sensors,
relative key press point sensors,
relative pedal press timing sensors, and
key touch positioning sensors.

6. The piano key press processor as claimed in claim 1, where:
said key press characteristics include at least one of the following:
key press timing,
pressed key count,
pressed key touch multiplicity,
relative pressed key proximity,
relative key press points,
relative pedal press timing, and
key touch positioning; and
said repurposing mean include at least one of the following:
note muting,
note replacing,
note shifting,
note doubling,
note supplementing, and
note sliding.

7. The piano key press processor as claimed in claim 1, where:
said sensing means include at least one of the following:
key press timing sensors,
key counting sensors,
key touch multiplicity sensors,
relative pressed key proximity sensors,
relative key press point sensors,
relative pedal press timing sensors, and
key touch positioning sensors; and
said repurposing means include at least one of the following:
note muting,
note replacing,
note shifting,
note doubling,
note supplementing, and
note sliding.

8. The piano key press processor as claimed in claim 1, where:
said key press characteristics include at least one of the following:
key press timing,
pressed key count,
pressed key touch multiplicity,
relative pressed key proximity,
relative key press points,
relative pedal press timing, and
key touch positioning;
said sensing means include at least one of the following:
key press timing sensors,
key counting sensors,
key touch multiplicity sensors,
relative pressed key proximity sensors,
relative key press point sensors,
relative pedal press timing sensors, and
key touch positioning sensors; and
said repurposing means include at least one of the following:
note muting,
note replacing,
note shifting,
note doubling,
note supplementing, and
note sliding.
